(19) United States
(12) Patent Application Publication
(10) Pub. No.: US 2007/0129022 A1
(43) Pub. Date: Jun. 7, 2007

(54) Method for adjusting mobile communication activity based on voicing quality

(76) Inventors: Marc A. Boillot, Plantation, FL (US); Philip A. Schentrup, Hollywood, FL (US); Vincent Vigna, Miami Springs, FL (US); Ali Behboodian, Natick, MA (US); Bradley J. Rainbolt, Sunrise, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/292,867

(22) Filed: Dec. 2, 2005

(51) Int. Cl. H04B 1/38

(52) U.S. Cl. 455/90.1; 455/95

(57) ABSTRACT

A mobile communication device (100) includes a vocoder (104) for vocoding speech (500) received at the mobile communication device. The parameters output by the vocoder are used to generate a voicing quality metric (208). The voicing quality metric is used to provide feedback to the user of the mobile communication device by various feedback modalities including visual (114), audible (108), and tactile modalities (118) to indicate when the user should speak louder to overcome ambient noise. The voicing quality metric is also used by other communications equipment (304, 312) to decide if communication activity is needed.

### TECHNICAL FIELD

The invention relates in general to mobile radio communications, and more particularly to the link quality of mobile communications between mobile communication radios.

### BACKGROUND OF THE INVENTION

In radio voice communication, link problems can arise between radios due to noise and other interference with the transmitted signal in the signal channel. Interference from other sources may disturb the channel. Multi-path effects of the signal being transmitted are also known to degrade link quality. Although efforts may be taken to reduce the effect of interference, often the interference combines with the signal in a way that results in corruption of the information being transmitted. The result is that the listener hears the effects of the interference, potentially corrupting the information to the point of making it, or parts of it, unintelligible.

However, interference in the channel between radios is not the only way in which a signal may become perceptively corrupted or distorted. Digital mobile voice communication relies on voice coding, or voice encoding, techniques to reduce the bandwidth needed to transmit voice information. Voice coding is performed by a vocoder, and takes advantage of the relatively slow time varying nature of speech, as well as other aspects of speech, to model speech with a set of parameters and coefficients. When speech in the acoustic audio signal is mixed with other acoustic sounds, generally referred to as background noise, the voice coding process becomes less effective, resulting in audio artifacts being mixed in with speech at the listener's equipment.

To the listener, it is difficult to determine, if possible at all, whether degraded speech received at their equipment from another party is the result of ambient acoustic conditions at the remote party, of if it is due to interference in the radio channel. Typically the listener will prompt the speaking party to “speak up,” and increase their speaking volume. The speaker, of course, has no way of knowing what their speech sounds like at the listener's equipment. Furthermore, communications equipment is constantly measuring radio link quality to determine if some communication process needs to be undertaken, such as a handover to a new serving cell, or to inform a user's equipment to increase transmission power. However, communication equipment does not evaluate the voicing quality of the information it is receiving for transport to another party, only the radio link quality. Therefore, there is a need by which users of communications systems can be informed as to the voicing quality of the speech signal they are transmitting so that preemptive action may be taken to address radio and voice processing issues.

### BRIEF DESCRIPTION OF THE DRAWINGS

FIG. 1 shows a block schematic diagram of a mobile communication device in accordance with an embodiment of the invention;

FIG. 2 shows a flow chart diagram illustrating a method of providing voicing quality feedback to a user of a mobile communication device, in accordance with an embodiment of the invention;

FIG. 3 shows a system diagram of a communication system and its operation in accordance with an embodiment of the invention,

FIG. 4 shows a data frame structure diagram, in accordance with an embodiment of the invention;

FIG. 5 shows a voice signal over time; and

FIG. 6 shows a flow chart diagram of a method of performing communication activity, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. The invention solves the problem of informing communication system users of the voicing quality of the speech signal they are transmitting by determining a voicing quality metric based on vocoder parameters produced while vocoding the audio signal at the speaker's equipment, and either making the voicing quality metric perceptible to the user, or using the voicing quality metric to compare with the radio signal reception quality to determine if there is a problem with the radio link.

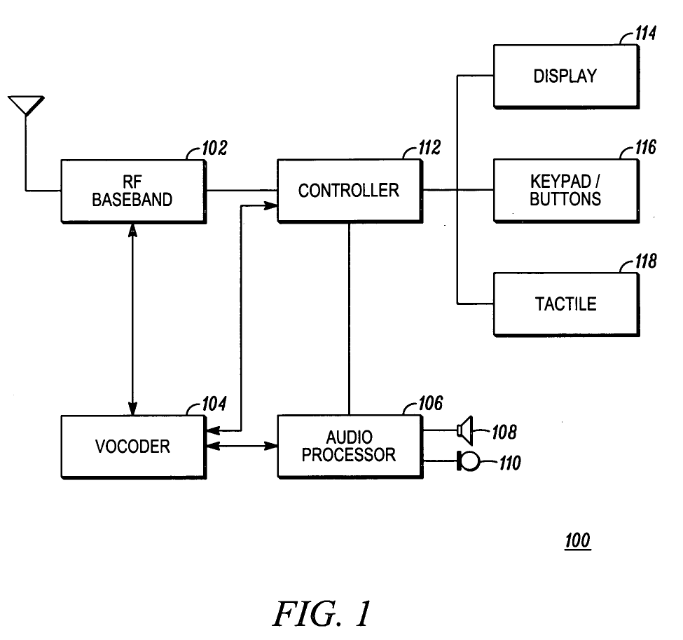

Referring now to FIG. 1, there is shown a block schematic diagram of a mobile communication device 100, in accordance with an embodiment of the invention. The mobile communication device includes a conventional digital radio transceiver 102, including a radio transmitter, radio receiver, mixers, oscillators modulators and a baseband processor for transmitting and receiving signals over a radio channel, including modulation and demodulation, and for processing baseband signals to be modulated and those that have been demodulated. The digital radio transceiver 102 is coupled to a vocoder 104, which is typically implemented by a digital signal processor, and which processes audio signals in connection with an audio processor 106. The audio processor converts analog audio signals received from a microphone 108 into digital form, and converts digital audio signals received from the vocoder to analog form to be played over a speaker 110. The vocoder performs encoding of digital signals received from the audio processor, and decoding of signals received from the digital radio transceiver 102. A controller 112 controls general operation of the mobile communication device, including RF and baseband processes, audio processes, and user interface functions. The controller also supports a user interface including display elements 114, keypad and button elements 116, and tactile elements 118. The display elements provide information visually, such as on a graphic display as well as various other light sources to indicate such things as battery status, power, connection status, and so on. The keypad and buttons allow the user to input information into the mobile communication device, as well as indicate selections and control operation of the mobile communication device. The tactile element 118 provides a tactile response to indicate information to the user. A simple example of a tactile element is a vibratory motor, for silently indicating an incoming call event.

According to an embodiment of the invention, as the user of the mobile communication device speaks into the microphone 108, an audio signal is digitized by the audio processor 106 and fed to the vocoder 104 for encoding. The audio signal contains the speech signal as well as any ambient noise that may have been present at the microphone while the user speaks. The vocoder encodes the speech and in so doing determines certain coefficients and parameters of the audio signal on a frame by frame basis. Typically included in the output of the vocoder is a voicing level parameter and a background noise parameter. The voicing level parameter indicates the degree to which the present frame appears to be voiced content, and may depend on certain characteristics such as pitch, pitch trajectory, periodicity, and so on. In frames that do not appear to be voiced, the vocoder may provide a noise estimation corresponding to the non-voiced content. During periods where the user is not speaking, the vocoder may output what are referred to as comfort noise frames which provide minimal acoustic content so that the receiving party still “hears” the user's call because a completely silent frame will often make a listener think the call has been disconnected or interrupted. The voicing level parameter may be directly output from the vocoder, or it may be determined by mathematical operation on a combination of parameters output by the vocoder. Comparing the voicing level parameter to the background noise parameter is one way of providing a voicing quality metric that indicates how well the speaker's voice overcomes the ambient noise. Various other vocoder parameters, depending on the vocoder, may be used to generate the voicing quality metric, so long as they relate to how well the speaker's voice overcomes ambient noise. The comparison may be made simply by a ratio of voicing level to background noise, but it is contemplated that these parameters may be scaled or weighted, or even adaptively scaled or weighted depending on the acoustic circumstances. If the voicing quality metric indicates the volume of the speaker's voice is not enough to sufficiently overcome the ambient noise, an indication may be given to the speaker to increase their speaking volume. The indication is provided in the form of perceptible feedback, such as, for example, visual, audible, tactile, feedback, or combinations thereof. For example, a light source such as an LED may be blinked, or flashed, or provided at a certain color to indicate a voicing quality problem. A vibration device may be employed equivalently to provide tactile feedback to the speaker, as another example. The precise selection of value in comparing the voicing quality metric with the background noise metric at which to prompt the user to adjust speaking manner is a matter of engineering choice, and will depend on the particular vocoder parameters used, the algorithm used by the vocoder, and the present acoustic conditions, for example. Furthermore, it is contemplated that the vocoder, upon detecting audio saturation, may reduce the gain of the microphone input. Audio saturation can occur in noisy environments where the user speaks much louder than normal, possibly over-compensating for ambient noise.

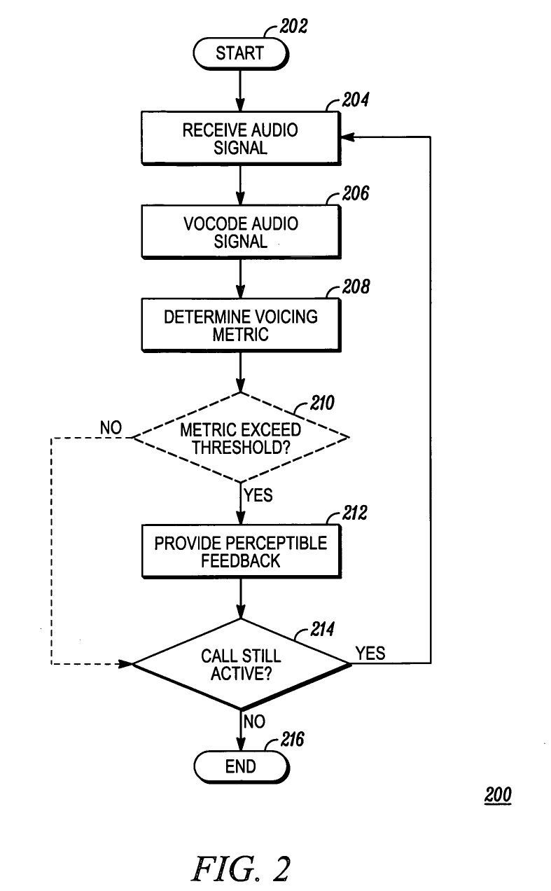

Referring now to FIG. 2, there is shown a flow chart diagram 200 illustrating a method of providing voicing quality feedback to a user of a mobile communication device, in accordance with an embodiment of the invention. The following exemplary method may be performed by a mobile communication device designed in accordance with that shown in FIG. 1. At the start (202) of the method, the mobile communication device is powered on and engaged in a voice call to another party. As the user of the mobile communication device speaks, an acoustic audio signal is received at the microphone and converted from analog to digital form (204). Typically this results in pulse code modulation stream of 8,000 byte samples per second. The digital audio is streamed to the vocoder, which encodes or vocodes the audio signal (206). The output of the vocoder is used to determine a voicing quality metric (208), such as, for example, a ratio of voicing level to noise. Optionally, a threshold may be implemented (210), and if the voicing quality metric exceeds or meets the threshold criteria, then the method commences, otherwise the mobile communication device may not provide feedback as the assumption is the voicing quality is acceptable. If the voicing quality is poor, and meets or exceeds the threshold, or if feedback is constantly provided in proportion to voicing quality, the mobile communication device provides perceptible feedback to the user to indicate the user should speak louder (212). The perceptible feedback may be in visual, audible, or tactile form, or a combination thereof. The method may be periodically repeated while the call is active (214). When the call is finished, the mobile communication device ceases to perform the method (216).

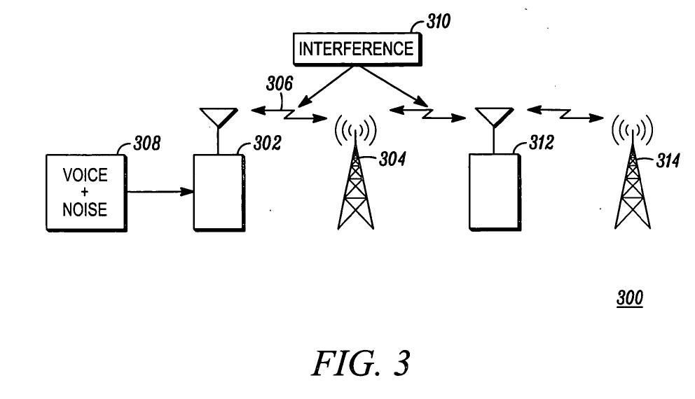

Referring now to FIG. 3, there is shown a system diagram of a communication system 300 and its operation, in accordance with an embodiment of the invention. Here the voicing quality metric is used to identify potential communication link issues. A first mobile communications radio 302, such as a mobile communication device, communicates with a second communications radio 304, such as a base station of a cellular communication system, over a wireless radio link 306. The mobile communication device calls a remote party equipment 312, and commences sending voice and ambient noise information over the call circuit to the remote party. As the signal is transmitted from the mobile communication device to the base radio, interference 310 may affect the signal of the radio link 306. The same is true of the signal between the base station and the remote party. Note that the same base station is shown here supporting both the mobile communication device 302 and the remote party 312; those familiar with the art will realize each mobile device may be affiliated with different base stations, or even different communication systems. According to the present embodiment of the invention, the mobile communication device 302 commences processing the audio signal by a vocoding process, and determining a voicing quality metric as discussed in reference to FIGS. 1 & 2. The voicing quality metric is providing in the signal transmitted to the base radio. The voicing quality metric may be embedded in frames of the signal, or provided, for example, during silence periods of the speech received from the user in place of sending comfort noise. The base radio, being the receiver of the signal, determines a reception quality metric, as is conventional. Typically a receiver in a mobile communication system will determine measurements such as radio signal strength index or indicator (RSSI) and signal quality estimate (SQE). This gives the receiver an indication as to the integrity of the radio link. The base radio of the present embodiment receives the voicing quality metric in the signal inbound from the mobile communication device. If the base radio detects a signal integrity issue, it compares the reception quality metric and voicing level metric to determine the potential source of the problem. If the voicing quality is within acceptable limits, then the problem is likely in the radio link itself, in which case the base radio transmits a control message causing the mobile communication device to take action such as increasing transmit power. If the voicing quality metric indicates a voicing problem, the base radio may send a control message to the mobile communication device, causing the mobile communication device to prompt the user to modify their speech, via one of the perceptible feedback modalities.

In another embodiment, infrastructure equipment such as the base radio and other infrastructure components conventionally pass the signal from one mobile communication device 302 to the remote mobile communication device 312. The remote mobile communication device 312 receives the signal originated by the calling mobile communication device 302 from a base radio 304. During a call between the mobile communication devices the mobile communication devices determine their respective voicing quality metrics, and insert the voicing quality metric into their outbound signal. As the mobile communication devices receive the respective signals, if the audio quality appears to be poor, the receiving mobile communication device can compare the reception quality metric and the received voicing quality metric to determine where the problem is occurring. If both metrics are within acceptable limits, then the assumption is there is a link problem between the transmitting mobile communication device and its respective base radio. In response, the receiving mobile communication device may send a message to the sending mobile communication device so that the sending mobile communication device may decide whether or not to search for a new base station 314, increase transmit power, prompt the user to raise the antenna, or other such corrective actions to improve transmit signal quality.

If the voicing quality metric is low then the assumption is ambient noise is interfering with the voice encoding process at the speaker's mobile communication device. In this case the receiving mobile communication device may reply with a message to the sending mobile communication device to prompt the user of the sending mobile communication device to speak differently (louder, slower, clearer, etc.) via any of the perceptible feedback modalities discussed previously. If the reception quality metric and voicing quality metric indicate a problem with reception from the present serving base station 304, the mobile communication device may search for a new base station 314 for a high quality signal.

Alternatively, the base station may send a control message to the mobile communication device to prompt the user to speak differently in an attempt to overcome channel interference, even when the voicing quality metric indicates the mobile communication device is producing high fidelity encoded voice.

In an embodiment of the invention, the mobile communication device determines an audio quality metric of the voice, such as a ratio of voicing level to background noise, a pitch trajectory, or another attribute representative of continuous voice. Pitch results from vibration of the vocal chords which are normally continuous and smooth over sufficiently short time periods. Speech varies relatively slowly because of the articulation requirements in producing voice. Hence, an audio quality metric or measure should be able to identify the attributes of good form voice, i.e. voice in good form with true voice characteristics. When the vocoder is poorly encoding, which can be due to background noise, the encoding performance becomes reduced and the parameters representing the encoded speech may not adequately comply with the slowly time varying model. For example, the vocoder parameters representing the pitch should have a smooth trajectory over vowelic portions of speech because vowelic speech is periodic. With significant background noise, the encoding may perturbate the pitch for certain frames which lead to a jumpy or jittery pitch track, or pitch rejection. The audio quality metric is not coupled with or related to the link quality estimates which use forward error correction (FEC) values or bit energy over noise figures (Eb/No) to determine signal strength. Improved link performance is typically attained with higher power or more forward error correction coding.

The mobile communication device may packetize the voicing quality metric within silence frames between speech content frames and send it to the base radio. The base radio is operably coupled to a transcoder, as is well known in the art. The transcoder decodes the data and assess the voice quality as well as the link quality. Note, if the link quality is bad, the audio quality will become corrupted. But if the link quality is good and the audio quality is poor, then the base radio assumes the mobile communication device is having difficulty encoding, likely due to environmental conditions like background noise. If so, the base radio may send a control packet to the mobile communication device to prompt the user to change speaking manner. The user may speak louder, slower, with more articulation, and so on. The base radio can determine if the voicing quality is poor by comparing an estimate it makes on the decoded speech with the voicing quality metric transmitted by the mobile communication device. The base radio may use the same evaluation criteria, and if the voicing quality metric produced by the base radio do not sufficiently match that provided by the mobile communication device, then it indicates a link problem. Link quality measured in this manner can be confirmed with the SQE and RSSI measurements.

If the vocoding at the mobile communication device is acceptable but the link is poor, then speaking slower may help retain the quality over the link because there are more packets given the same number of encoding errors. For example, if the link distorts every other frame, by slowing speech in half, then twice as many good frames are received, which, although doesn't improve quality so much as intelligibility. Alternatively, if the user articulates differently, which affects pronunciation, inflection, intonation, and pitch, it may condition the speech to be more robust to the communication channel errors. In practice the errors are randomly distributed, like burst, convolution, and so on. If the user speaks with more inflection than the pitch trajectory has more emphasis, it is more dynamic. If the user speaks with more intonation, the pitch track better exhibits characteristic behaviors, such as an upward frequency sweep near the end of words. Vocoders depend on pitch and are sensitive to reconstruction errors when the pitch estimates are off. Accordingly, link errors can affect pitch values which will deteriorate reconstructed audio quality. Accordingly, prompting the user to speak differently can alter the way the decoder reconstructs speech in poor link conditions. Also, in variable rate vocoders or differential vocoders, providing pronounced variation or limiting variation can affect the encoding process. Highly inflected voices will have wider dynamic range which can reduce sensitization to quantization noise. Increasing inflection thus may improve robustness when link errors corrupt the encoding parameters. Wider dynamic range requires the vocoder to allocate more bits to those fields. Requesting the user to speak differently introduces variance and redundancy into the encoding parameters which can increase the robustness of the parameters across the link.

In addition to the voicing quality, the mobile communication device, according to one embodiment of the invention, may provide a comprehensive signal quality indication, including the present voicing quality and the present radio link quality. The present radio link quality is based on the signal received from a base radio with which the mobile communication device is presently affiliated, and may be based on radio signal strength index (RSSI), signal quality estimation (SQE), the degree of forward error correction, bit error rate, and so on. The mobile communication device may indicate its radio link quality or comprehensive signal quality to the user via perceptible feedback. The comprehensive signal quality, which may include both the voicing quality metric and radio link quality metric, indicates the overall quality of the signal as received by the base radio, but may be passed on to the remote party. Having both indicators of voicing quality and radio link quality allows for decisions as to what sort of communication action may be taken to improve the quality of the signal heard by the remote party. If the voicing quality is high, but the radio link quality is low, remote radios may send control messages to the originating mobile communication device to improve signal conditions, such as by raising an antenna, increasing transmit power, handing over to a different serving cell, and so on. Likewise, if radio link quality is high, but the voicing quality is low, remote radios may send control messages to prompt the user of the originating mobile communication device to speak differently (louder, slower, etc). in an attempt to improve voicing quality.

Furthermore, the comprehensive signal quality received from the initiating party may be high, while the remote party's reception quality may also be high, but the decoded audio quality at the remote party may be low. Such conditions indicate a problem in the link from the initiating party to the communication system, also known as the inbound link. In this situation the remote party's device may respond with a control message to the initiating party to take corrective action, such as adjusting transmission parameters, or prompting the user to speak differently.

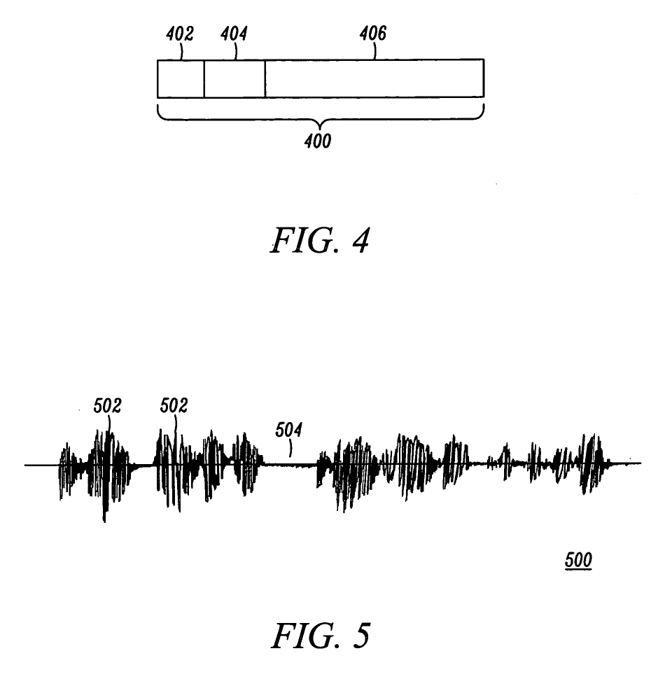

Referring now to FIG. 4, there is shown a data frame structure diagram, in accordance with an embodiment of the invention. The data frame 400 represents one frame of data transmitted by a mobile communication device in accordance with the invention. The data frame is also representative of what is received by the receiving mobile communication device. The data frame is a sequence bits containing digital information, as is well known. The data frame typically includes a header 402, including special fields 404, and a payload 406 which may include vocoded voice data. In one embodiment of the invention, as frames are produced by the vocoder, the voicing quality metric is included in the special field section 404 of the frame to ensure it is received.

FIG. 5 illustrates an alternative method of including voicing quality metric. FIG. 5 shows a voice signal 500 over time. There are periods of speech 502, with periods of no speech or “silence” 504 interspersed in the speech, even when the speaker is actively speaking. The silence period may not be truly silent due to ambient noise, but the vocoder detects a lack of speech in these times. It is during these silence periods that the vocoder may insert voicing quality metrics. The voicing quality metric may be one determined for a recent frame, or a running average of recently transmitted frames. Alternatively, the vocoder may insert the voicing quality metric into the payload section as taught in published patent application no. 2004/0220803, titled “Method and Apparatus for Transferring Data Over a Voice Channel,” which is commonly assigned to the assignee of the present invention.

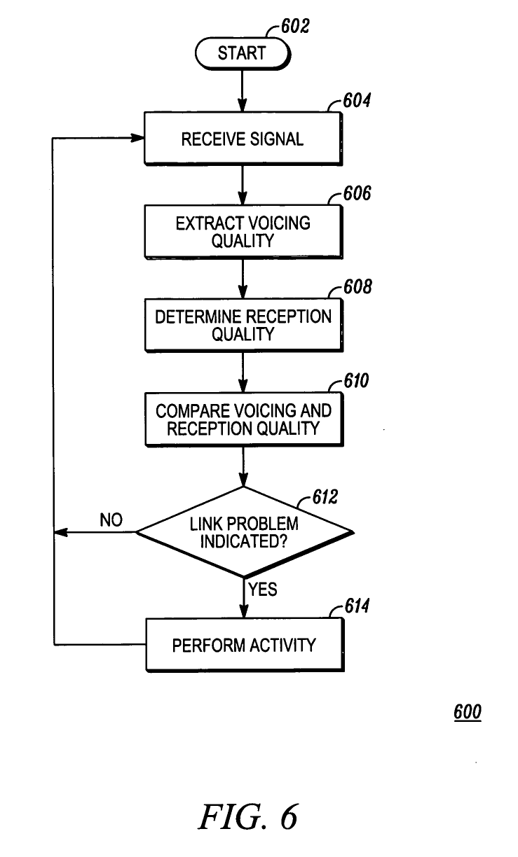

Referring now to FIG. 6, there is shown a flow chart diagram 600 of a method of performing communication activity, in accordance with an embodiment of the invention. At the start 602 of the method a remote party's mobile communication device is ready to receive a signal, such as during a call, from another mobile communication device. The mobile communication device commences receiving 604 the signal as transmitted by the base radio with which it is affiliated. As the signal is received, the remote party's mobile communication device extracts the voicing quality metric 606, and determines the reception quality metric 608. The reception quality metric indicates the quality of the radio link between the receiving mobile communication device and the base radio with which it is presently affiliated. In addition, the sending mobile communication device may include a radio link quality metric of its own, indicating the quality of radio link between the sending mobile communication device and the base radio with which it is presently affiliated. The voicing quality metric and radio link quality metric may be transmitted together by the sending mobile communication device to indicate a comprehensive signal quality of the sending mobile communication device as transmitted to its affiliated base radio. The metrics may be compared 610 by the remote party's mobile communication device. If a link problem is indicated by the comparison 612, either between the sending mobile communication device and its affiliated base radio, or between the remote party's mobile communication device and its affiliated base radio, the remote party's mobile communication device may commence a communication activity, such as changing base affiliation to a closer base station, or transmitting a message to the sending mobile communication device to prompt the speaker to speak differently, or to take some action with regard to improving the sending mobile communication device's link such as increasing transmit power, prompting the user to raise the antenna, switching to a different serving cell, and so on.

Thus, the invention provides a method of providing voicing quality feedback to a user of a mobile communication device, commenced by receiving an audio signal containing voice information at the mobile communication device, via, for example a microphone, and vocoding the audio signal into a vocoded signal. The output of the vocoder is used for determining a present voicing quality metric of the vocoded signal. The method then commences providing perceptible feedback to the user of the mobile communication device in correspondence to the present voicing quality metric. The perceptible feedback may include provide a visual, audible, or tactile feedback. In one embodiment the voicing quality metric is determined by the voicing level parameter and the background noise parameter, such as by a ratio.

The invention also provides a method of informing a remote party of a calling party's voicing quality, commenced by receiving an audio signal containing voice information at the mobile communication device, followed by vocoding the audio signal into a vocoded signal. The output data of the vocoder or vocoding process is used in determining a present voicing quality metric of the vocoded signal. The mobile communication device then commences transmitting the present voicing quality metric to the remote party, and may further transmit a comprehensive signal quality indication including the voicing quality metric and a radio ling quality metric. The voicing quality metric may be determined by the voicing level parameter, pitch parameter, pitch trajectory parameter, along with a parameter indicating back ground noise. The voicing quality metric may be inserted into silence period frames, or in fields in the frame structure with the vocoded voice data. The voicing quality metric may be used by the receiving mobile communication device to let the remote party know audio quality is suffering due to link conditions, not because of ambient noise at the speaker's equipment.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of providing voicing quality feedback to a user of a mobile communication device, comprising:
receiving an audio signal containing voice information;
vocoding the audio signal into a vocoded signal;
determining a present voicing quality metric of the vocoded signal; and
providing perceptible feedback to the user of the mobile communication device in correspondence to the present voicing quality metric.

2. A method of providing voicing quality feedback as defined in claim 1, wherein providing perceptible feedback comprises providing a visual indication of voicing quality.

3. A method of providing voicing quality feedback as defined in claim 2, wherein providing a visual indication of voicing quality comprises providing the visual indication on a display of the mobile communication device.

4. A method of providing voicing quality feedback as defined in claim 1, wherein providing perceptible feedback comprises providing tactile feedback.

5. A method of providing voicing quality feedback as defined in claim 1, wherein providing perceptible feedback comprises providing audible feedback.

6. A method of providing voicing quality feedback as defined in claim 1, wherein determining the present voicing quality metric is performed using a ratio of a present voicing level parameter of the vocoded signal and a present background noise parameter of the vocoded signal.

7. A method of informing a remote party of a calling party's comprehensive signal quality, comprising:
receiving an audio signal containing voice information;
vocoding the audio signal into a vocoded signal;
determining a present voicing quality metric of the vocoded signal; and
transmitting the present voicing quality metric to the remote party.

8. A method of informing a remote party of a calling party's comprehensive signal quality as defined in claim 7, further comprising:
determining a present radio link quality metric between the calling party and a present base radio with which the calling party is presently affiliated; and
transmitting the present radio link quality with the present voicing quality metric.

9. A method of informing a remote party of a calling party's comprehensive signal quality as defined in claim 7, wherein determining the present voicing quality metric of the vocoded signal is performed using a ratio of a present voicing level parameter of the vocoded signal and a present background noise parameter of the vocoded signal.

10. A method of informing a remote party of a calling party's comprehensive signal quality as defined in claim 7, wherein transmitting the present voicing quality metric comprises including the present voicing quality metric in a present frame of vocoded signal.

11. A method of informing a remote party of a calling party's comprehensive signal quality as defined in claim 10, wherein including the present voicing quality metric in a present frame of vocoded signal comprises inserting the present voicing quality metric in an unvoiced frame of the vocoded signal.

12. A method of informing a remote party of a calling party's comprehensive signal quality as defined in claim 7, further comprising:
receiving a received signal at a mobile communication device of the remote party corresponding to the vocoded signal, the received signal including the present voicing quality metric;
providing a perceptible indication at the mobile communication device of the remote party in correspondence to the present voicing quality metric.

13. A method of mobile communications, comprising:
transmitting a vocoded signal from a first mobile communications radio to a second mobile communications radio, the vocoded signal containing speech information and a voicing quality metric related to the speech information;
receiving a received signal resulting from the transmitted vocoded signal at the second mobile communications radio;
determining a reception quality metric of the received signal;
comparing the reception quality metric with the voicing quality metric; and
performing a communications procedure if comparing the reception quality metric with the voicing quality metric indicates a link problem between the first and second mobile communications radios.

14. A method of mobile communications as defined in claim 12, wherein the first mobile communications radio is a mobile communication device, the second mobile communications radio is a base radio, performing the communications procedure comprises transmitting a control message to the mobile communication device from the base radio to adjust a transmission power of the mobile communication device.

15. A method of mobile communications as defined in claim 12, wherein the first mobile communications radio is a mobile communication device, the second mobile communications radio is a base radio, performing the communications procedure comprises transmitting a control message to the mobile communication device from the base radio to prompt a user of the mobile communication device to adjust the user's speaking manner.

16. A method of mobile communications as defined in claim 12, wherein the first mobile communications radio is a base radio, the second mobile communications radio is a mobile communication device, performing the communications procedure comprises:
searching for an alternative base station at the mobile communication device; and
upon locating an alternative base station, initiation a handover to the alternative base station.

17. A method of mobile communications as defined in claim 12, wherein the voicing quality metric is a ratio of a present voicing level parameter of the vocoded signal and a present background noise parameter of the vocoded signal.

18. A method of mobile communications as defined in claim 12, wherein the reception quality metric is based on at least one of a radio signal strength indicator parameter and a bit error rate parameter.
